(19) United States
(12) Patent Application Publication
(10) Pub. No.: US 2005/0218065 A1
(43) Pub. Date: Oct. 6, 2005

(54) Filter

(76) Inventor: Bruce Scott-Smith, Northmead (AU)

Correspondence Address: HOGAN & HARTSON LLP, ONE TABOR CENTER, SUITE 1500, 1200 SEVENTEENTH ST, DENVER, CO, 80202, US

(21) Appl. No.: 10/818,691

(22) Filed: Apr. 5, 2004

(51) Int. Cl. B01D 29/50

(52) U.S. Cl. 210/337; 210/315; 210/497.3; 210/483

(57) ABSTRACT

A filter includes three separate conical filter elements each of which is supported on top of a support element. Each of the support elements has a substantially conical portion for location of a filter element. The conical portion is in turn mounted on a substantially cylindrical portion. The surfaces of the conical filter elements are each preferably orientated at an angle of 35° to the base of the cone and each filter element preferably mounted with a clearance of 25 mm between it and the conical support. The uppermost filter element preferably has a 1mm mesh, the middle filter element preferably has a 50 micron mesh and the lowermost filter element preferably has a 1 micron mesh. The middle and outermost cylindrical portions have apertures through them adjacent their open ends. A funnel is mounted above and substantially co-axial with the filter elements. The inner surface of the funnel carries a series of or ridges which extend arcuately inwards and downwards within the funnel in the anti-clockwise direction (for operation in the Southern hemisphere) when viewed from the inlet end of the funnel. A distributor cone is mounted above the funnel, with the axis substantially co-axial with the axes of the funnel and the filter elements and with its periphery terminating within the catchment area of the funnel.

### BACKGROUND OF THE INVENTION

1. Field of the Invention

The present invention relates to filters, and various embodiments of it are particularly suitable as a rainwater filter.

2. Background Art

There are a number of environments which require the filtration of solid material from a fluid flow. Examples include the filtration of metal cuttings from cutting oil used in conjunction with machine tools, and the filtration of solid materials from rain water.

Rainwater tanks that are in use in Australia generally receive water through a concave strainer which has a mesh of about 1 mm (that is, about 1,000 microns). Such a strainer acts as a simple primary filter which traps leaves, twigs, large solids and dollops of bird faeces.

These filters have a number of disadvantages, including that they block up and that the dollops of bird faeces dissolve in the water. The water stored in the rainwater tank is thus high in bird faecal coliform count.

### SUMMARY OF THE INVENTION

In one aspect the present invention accordingly provides a filter for the filtration of fluids, which filter includes:
at least one filter element, in which at least a portion of the surface of the filter element is not normal to the direction of flow of fluid through the filter; and
means for producing a component of the fluid flow across an upstream surface of the filter element in a direction other than radially away from the direction of flow of fluid through the filter.

In another aspect the present invention accordingly provides a filter for the filtration of fluids, which filter includes at least one filter element, and in which filter there is a flow of fluid:
with a component of the fluid flow in a direction parallel to the upstream surface of the filter element; and
a component of the fluid flow in a direction through the filter element.

In yet another aspect the present invention accordingly provides a filter for the filtration of fluids, which filter includes:
at least one filter element, at least one portion of which filter element has a surface which is orientated so that a normal to it is at an angle of between 25° and 45° to the direction of bulk flow of fluid through the filter.

The component of fluid flow across the upstream surface of a filter element (as distinct from through the filter element) thus results in the filter being self-cleaning to some extent.

### DESCRIPTION OF THE DRAWINGS

FIG. 1 is a plan view, partially showing hidden detail, of apparatus according to one embodiment of the present invention.

FIG. 2 is a cross-sectional view on the line AA of FIG. 1.

### DESCRIPTION OF PREFERRED EMBODIMENTS OF THE INVENTION

Construction

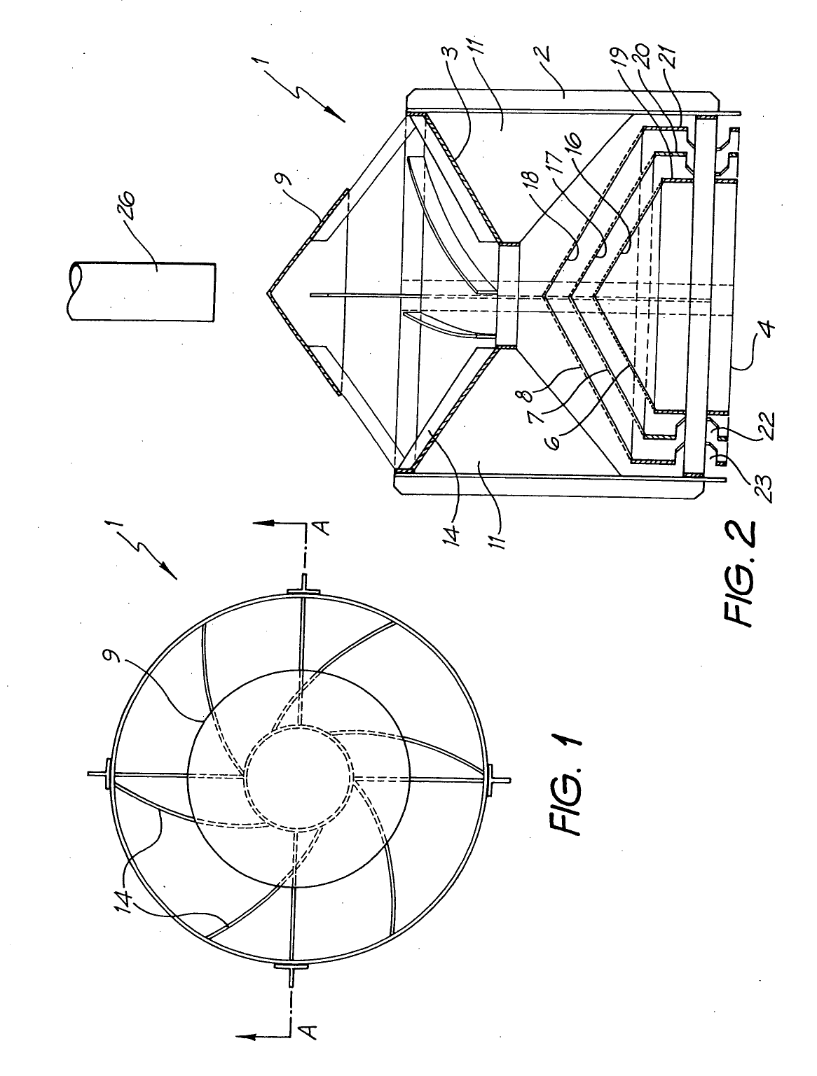

Apparatus 1 according to one embodiment of the present invention is illustrated in FIGS. 1 and 2. The apparatus 1 includes three separate conical filter elements 6, 7 and 8, each of which filter elements is supported on top of a support element 16, 17 and 18 respectively. Each of the support elements 16, 17 and 18 includes a substantially conical portion for location of a filter element, which conical portion is in turn mounted on a substantially cylindrical portion 19, 20 and 21 respectively.

In the present embodiment, it is especially preferred that the surface of the conical filter elements 6, 7 and 8 are each orientated at an angle of 35° to the base of the cone. In this embodiment the cones are mounted with a clearance of 25 mm between each filter element and the conical support above it. According to this embodiment, the uppermost filter element 8 has a 1 mm mesh, the middle filter element 7 has a 50 micron mesh and the lowermost filter element 6 has a 1 micron mesh. It will be understood that, according to other preferred forms of the invention, and depending on the fluid flow rate, quality and debris content, either or both of the mesh sizes of the filter elements and the number of filter elements varies.

Each support element 16, 17 and 18 is hollow to allow the nested mounting of each element within a larger element, with the conical portions uppermost and the substantially cylindrical portions 19, 20 and 21 lowermost. An open end of the cylindrical portion 19 defines an aperture for mounting in register with the opening to a water tank or the like.

The middle and outermost cylindrical portions 16 and 17 have apertures 22 and 23 through them adjacent their open ends.

A funnel 3 is mounted above, and substantially co-axial with, the filter elements 6, 7 and 8. The inner surface of the funnel 3 carries a series of ridges 14 which extend arcuately inwards and downwards within the funnel 3 in the anti-clockwise direction when viewed from the inlet end of the funnel.

A distributor cone 9 is mounted above the funnel 3, with the axis substantially co-axial with the axes of the funnel 3 and the filter elements 6, 7 and 8 and with its periphery terminating within the catchment area of the funnel 3. It is preferred that web stays 11 support the funnel 3.

According to an alternative preferred form of the invention, a downpipe such as the pipe 26 is mounted substantially coaxial with and above the distributor cone 9.

Operation

In use, fluid from a downpipe or the like is directed onto the distributor cone 9 (preferably through a pipe such as the pipe 26). The fluid then flows from the outer periphery of the distributor cone 9 into the funnel 3, where the ridges 14 impart a swirling or cyclone type flow pattern to the fluid stream. This fluid flow then impacts on the uppermost conical filter element 8 with a component of flow through the filter element and components of flow across the surface of the filter element, to eventually flow off the edge of the filter element and carry entrained debris with it. It has been found that the orientation of the cone surface at the angle of about 35° to the base of the cone discourages the retention of debris on the cone. The swirling flow imparted to the fluid stream by the funnel 9 and its ridges 14 aims at producing an erratic distribution of the flow impact areas around the surface of at least the uppermost conical filter element 8, so that any clogging of the filter element by debris is not concentrated at one area.

Similarly, fluid flows onto the surface of the middle filter element 7 and a component of this flow is across that surface, carrying entrained debris with it. This flow is then outwards through the aperture 23 in the outermost cylindrical portion 21. The fluid flow through the middle filter element 7 is then onto the bottom filter element 6. Again, a component of this flow is across the surface of the filter element 6, carrying entrained debris out of the filter through the apertures 22 and 23 in the cylindrical portions 19 and 20 respectively.

The entrained debris which are carried out of the filter as described above do not aggregate on the surface of the filter elements 6, 7 or 8 or within their meshes and this contributes to a ‘self cleaning’ facility of the filter.

In accordance with the requirements of local government authorities in Australia in the case where the fluid is rainwater the water carrying entrained debris and any overflow water from the filter is directed into the storm water system by means which are not illustrated in the drawings. It has also been found that, where the fluid is rainwater flowing from a downpipe, only one filter element 8 need be used if the mesh size of the filter is about 200 microns. When the filter element 8 is a polyamide mesh of 210 microns aperture, it has been found both that filtration of the water is adequate and that water exiting the filter element 8 is not flowing with adequate momentum to pass through subsequent filter elements. Also, it has been found that such a filter element reduces faecal coliform count.

Although the invention has been described above primarily in the context of its use as a rainwater filter, it is to be understood that the filter may be used in other environments. For example, in alternative embodiments of the invention, a relatively small portable version of the invention is provided for use in remote areas. According to this embodiment, relatively poor quality flowing or standing water is manually poured into the filter for filtration. In such an environment, the filter according to the present invention may be followed by a quick flow carbon filter to remove odour or colour from the water. In other environments such as remote mining or rural communities, large scale embodiments of filters according to the present invention may be used in the course of water reticulation to the community.

1. A filter for the filtration of fluids, which filter includes:
at least one filter element, in which at least a portion of the surface of the filter element is not normal to the direction of flow of fluid through the filter; and
means for producing a component of the fluid flow across an upstream surface of the filter element in a direction other than radially away from the direction of flow of fluid through the filter.

2. A filter as claimed in claim 1, in which the at least one filter element is substantially conical in shape.

3. A filter as claimed in claim 1, in which the at least one filter element is nested within another filter element.

4. A filter as claimed in claim 1, in which the at least one filter element is supported on a support element.

5. A filter as claimed in claim 1, in which a filter element furthest upstream has a mesh size in the range of 100 microns to 1,000 microns.

6. A filter as claimed in claim 5, further including a filter element which has a mesh size in the range of 10 microns to 100 microns.

7. A filter as claimed in claim 6 in which a filter element furthest downstream has a mesh size in the range 0.5 microns to 10 microns.

8. A filter as claimed in claim 4, in which at least one support element has an aperture through it in a region of the support element which is remote from the supported filter element.

9. A filter for the filtration of fluids, which filter includes at least one filter element, and in which filter there is a flow of fluid:
with a component of the fluid flow in a direction parallel to the upstream surface of the filter element; and
a component of the fluid flow in a direction through the filter element.

10. A filter as claimed in claim 9, in which the at least one filter element is substantially conical in shape.

11. A filter as claimed in claim 9, in which the at least one filter element is nested within another filter element.

12. A filter as claimed in claim 9, in which the at least one filter element is supported on a support element.

13. A filter as claimed in claim 9 in which a filter element furthest upstream has a mesh size in the range of 100 microns to 1,000 microns.

14. A filter as claimed in claim 13, further including a filter element which has a mesh size in the range of 10 microns to 100 microns.

15. A filter as claimed in claim 14 in which a filter element furthest downstream has a mesh size in the range 0.5 microns to 10 microns.

16. A filter as claimed in claim 12, in which at least one support element has an aperture through it in a region of the support element which is remote from the supported filter element.

17. A filter as claimed in claim 9, further including means for producing a component of the fluid flow across an upstream surface of the at least one filter element in a direction other than radially away from the direction of flow of fluid through the filter.

18. A filter as claimed in claim 17, in which the means for producing a component of the fluid flow across an upstream surface of the at least one filter element in a direction other than radially away from the direction of flow of fluid through the filter is a funnel which includes ridges in an inside wall of the funnel.

19. A filter as claimed in claim 18, further including a distributor cone which is mounted upstream of the funnel.

20. A filter for the filtration of fluids, which filter includes:
at least one filter element, at least one portion of which filter element has a surface which is orientated so that a normal to it is at an angle of between 25° and 45° to the direction of bulk flow of fluid through the filter.

21. A filter as claimed in claim 20, in which the angle is 35°.

22. A filter as claimed in claim 20, in which:
the at least one portion of the at least one filter element is substantially conical in shape; and
the at least one filter element which is mounted within the filter with the axis of the conical portion substantially parallel to the direction of bulk flow of fluid through the filter.

23. A filter as claimed in claim 20, in which the at least one filter element is nested within another filter element.

24. A filter as claimed in claim 20, in which the at least one filter element is supported on a support element.

25. A filter as claimed in claim 20 in which a filter element furthest upstream has a mesh size in the range of 100 microns to 1,000 microns.

26. A filter as claimed in claim 25, further including a filter element which has a mesh size in the range of 10 microns to 100 microns.

27. A filter as claimed in claim 26 in which a filter element furthest downstream has a mesh size in the range 0.5 microns to 10 microns.

28. A filter as claimed in claim 24, in which at least one support element has an aperture through it in a region of the support element which is remote from the supported filter element.

29. A filter as claimed in claim 20, further including means for producing a component of the fluid flow across an upstream surface of at least one filter element in a direction other than radially away from the direction of flow of fluid through the filter.

30. A filter as claimed in claim 29, in which the means for producing a component of the fluid flow across an upstream surface of at least one filter element in a direction other than radially away from the direction of flow of fluid through the filter is a funnel which includes ridges in an inside wall of the funnel.

31. A filter as claimed in claim 30, further including a distributor cone which is mounted upstream of the funnel.
